(19) United States
(12) Patent Application Publication
(10) Pub. No.: US 2025/0244213 A1
(43) Pub. Date: Jul. 31, 2025

(54) Interchangeable Support Including an Analyte Concentrator-Microreactor Device for Attachment to a Capillary Electrophoresis Cartridge-Cassette

(71) Applicant: Princeton Biochemicals, Inc, Princeton, NJ (US)

(72) Inventor: Norberto A. Guzman, Princeton, NJ (US)

(21) Appl. No.: 19/180,600

(22) Filed: Apr. 16, 2025

Related U.S. Application Data
(63) Continuation-in-part of application No. 29/841,206, filed on Jun. 3, 2022, now Pat. No. D078086.

(51) Int. Cl. G01N 1/40; B01L 3/00

(52) U.S. Cl. CPC G01N 1/40; B01L 3/502715; B01L 2200/027; B01L 2200/04; B01L 2200/0647

(57) ABSTRACT

A modular, interchangeable, and integrated unitarian support system containing an analyte contractor-microreactor (ACM) device in which analyte concentration and or micro-reactions are carried out on on-line, in-situ location. The interchangeable support system includes a support platform having a main body with one or more apertures therein. A docking support cartridge cassette includes one or more pole supports extending from the docking support cartridge cassette and being respectively removably received in the one or more respective apertures of the main body of the support platform. The analyte concentrator-microreactor (ACM) device being removably coupled to the support platform. The interchangeable support system allows the analyte concentrator-microreactor (ACM) device to be expeditiously coupled to the docking support cartridge cassette to perform on-line a variety of molecular interactions including preconcentration, biochemical, metabolic or bioactivity studies.

### BACKGROUND OF THE INVENTION

### Field of the Invention

The invention relates generally to the analysis of chemical and biological materials and, more particularly, to a modular, hybrid, interchangeable support system including an analyte concentrator-microreactor device, docking base and support platform to be coupled in complementary docking alignment to a cartridge-cassette used with a capillary electrophoresis instrument for the affinity capture, purification, enrichment, separation, identification, and characterization of a wide range of low-and high-molecular mass proteins and peptide biomarkers, and a large diversity of analytes found at a wide range of concentrations in simple and complex chemical-biochemical mixtures, including cellular and subcellular entities as well as vesicles and micro-nanoparticulate matter.

### Description of Related Art

Sample preparation in bioanalytical chemistry encompasses processes during which a targeted analyte is extracted from a simple or complex mixture for further analysis of the isolated molecule(s). In the case of biological fluids and tissue extracts, there are a larger number of sample constituents and in many cases the analytes of interest are found at very low abundances. Therefore, sample preparation is a crucial step to isolate and concentrate one or more target analytes from a mixture and for obtaining the correct and informative results of its/their chemical composition(s). Various sample collection and sample preparation for numerous chemical and biological compounds have been described. (de Souza et al., Metabolites 2024, volume 14, issue 1, https://doi.org/10.3390/metabol14010036; Ingle et al., Journal of Pharmaceutical Analysis 2022, volume 12, pages 517-529; Pena-Pereira et al., Current Opinion in Green and Sustainable Chemistry 2021, volume 30, https://doi.org/10.1016/j.cogsc.2021.100481; Kennedy et al., PLOS ONE 2014, volume 9, issue 2, https://doi.org/10.1371/journal.pone.0088982; Xia et al., Analytical Chemistry 2020, volume 92, issue 1, pages 34-48). Solid-phase extraction methods based on principles of specific and non-specific binding affinities have been used in the preparation process of biological fluids and tissue or food extracts (Calavera et al., Toxins 2024, volume 16, issue 1, https://doi.org/10.3390/toxins16010046; Mahdavijalal et al., Molecules 2024, volume 29, issue 10, https://doi.org/10.3390/molecules29102278; Zhang et al., Journal of Pharmaceutical Analysis 2023, volume 13, issue 5, pages 442-462; El Hosry et al., Foods 2023, volume 12, issue 4, https://doi.org/10.3390/foods12040895; Cheng et al., Forensic Science International: Synergy 2023, volume 6, https://doi.org/10.1016/j.fsisyn.2022.100303; Saito et al., Handbook of Analytical Separations 2020, volume 7, pages 1-13; Rodriguez et al., Journal of Chromatography B: Analytical Technologies in the Biomedical and Life Sciences 2020, volume 1157, https://doi.org/10.1016/j.chromb.2020.122332; Guzman, Electrophoresis 2003, volume 24, pages 371-3727; Guzman et al., Electrophoresis 2001, volume 22, pages 3602-3628).

Affinity capture technologies to selectively isolate, enrich, and purify a target analyte from a simple or complex matrix, and which span at a wide range of concentrations have been used in the discovery, screening, and quantification of biomarkers present in biological samples such as for example, serum, urine, saliva, tears, breath exhale, and other bodily fluids, tissues, cells, organelles, vesicles, (Tsai et al., U.S. Patent Application Publication No. US 2016/0208241; Kim et al., Expert Review of Proteomics 2018, volume 15, issue 4, pages 353-366; https://doi.org/10.1080/14789450.2018.1450631; Neubert et al., Clinical Chemistry 2020, volume 66, issue 2, pages 282-301; https://doi.org/10.1093/clinchem/hvz022; Hendrickson et al., U.S. Patent Application Publication No. US 2020/0199577; Liu et. al., U.S. Patent Application Publication No. US 2020/0407723; Halvorsen et al., Analytica Chimica Acta 2021, volume 1182, https://doi.org/10.1016/j.aca.2021.338714). The determination of a panel of biomarkers in biosamples has been used to obtain an accurate diagnosis of a disease. A combination of biomarkers has been used in the diagnosis and prognosis of the diseases (Chitnis T., et al., Nature Communications 2024, volume 15, https://doi.org/10.1038/s41467-024-48602-9; Guzman et al., International Journal of Translational Medicine 2024, volume 4, issue 2, pages 309-333; Hartl et al., EMBO Molecular Medicine 2023, volume 15, https://doi.org/10.15252/emmm.202216061; Firpo et al., JCO Clinical Cancer Informatics 2023, volume 7, https://doi.org/10.1200/CCI.22.00160; Kang et al., Obstetrics & Gynecology Science 2022, volume 65, issue 4, pages 346-354; Hardy-Sosa et al., Frontiers in Aging Neuroscience 2022, volume 14, https://doi.org/10.3389/fnagi.2022.683689; Smith et al., Biophysical Reviews 2021, volume 13, pages 1179-1190; Muinao et al., Heliyon 2019, volume 5, issue 12, https://doi.org/10.1016/j.heliyon.2019.e02826; Lima et al., British Journal of Cancer 2019, volume 121, pages 857-868).

Diagnosis is a fundamental part of clinical medicine and is a prerequisite for the delivery of high-quality effective care (Yang et al., Journal of the American Medical Association 2021, volume 326, pages 1905-1906); Maitra et al., Journal of the American Medical Association 2021, volume 326, pages 1907-1908). Providing accurate and accessible diagnoses is a fundamental challenge for global healthcare systems (Richens et al., Nature Communications 2020, volume 11, https://doi.org/10.1038/s41467-020-17419-7). Despite its essential place in medical practice, diagnostic performance is understudied and unmeasured. Excellence in diagnosis is assumed rather than demonstrated, and diagnostic acumen is often financially unrewarded (Yang et al., Journal of the American Medical Association 2021, volume 326, pages 1905-1906). In the United States alone an estimated 5% of outpatients receive the wrong diagnosis every year (Richens et al., Nature Communications 2020, volume 11, https://doi.org/10.1038/s41467-020-17419-7; Singh et al., BMJ Quality & Safety 2014, volume 23, pages 727-731; Singh et al., BMJ Quality Safety 2017, volume 26, pages 484-494; Morton, Australian Family Physician 2014, volume 43, pages 391-393). Diagnostic error can be broadly defined as a diagnosis that is missed, wrong or delayed, as detected by some subsequent definitive test, or finding, but other definitions have been described (Hunter et al., Frontiers in Public Health 2024, volume 12, doi: 10.103389/fpubh.2024.1479759). These errors are particularly common when diagnosing patients with serious medical conditions, with an estimated 5%-20% of these patients being misdiagnosed commonly at the primary care level, and one in three of these misdiagnoses resulting in serious harm (Ramaswamy et al., World Journal of Critical Care Medicine 2024, volume 13, issue 2, https://doi.org/10.5492/wjccm.v13.i2.89644; Singh et al., BMJ Quality Safety 2017, volume 26, pages 484-494; Graber, BMJ Quality Safety 2013, volume 22, pages ii21-ii27; Singh et al., Journal of the American Medical Association-Internal Medicine 2013, volume 173, pages 418-425). The risk of death, significant permanent injury, and prolonged hospitalization is higher for diagnostic error cases than for other medical errors (Kawamura, et al., JMIR Medical Informatics 2022, volume 10, issue 1, https://doi.org/10.2196/35225; Newman-Toker, BMJ Quality & Safety 2024, volume 33, pages 109-120). Missed vascular events, infections, and cancers account for about 75% of serious harms from diagnostic errors (Newman-Toker et al., Diagnosis (Berlin) 2020, volume 8, issue 1, pages 67-84).

An erroneous diagnosis can lead to wrong treatment, such as a surgery that is not necessary, and/or to prescribing a wrong medication. The total cost of looking after patients with medication-associated errors exceeds US$40 billion each year, with over 7 million patients affected (Tariq, et al., In: StatPearls, Treasure Island (Fl.): StatPearls Publishing, 2024, https://www.ncbi.nlm.gov>books>NBK519065; Oyibo et al., JMIR Human Factors 2024, volume 11, https://doi.org/10.2196/41557). In addition to the monetary cost, patients experience psychological and physical pain and suffering as a result of medication inaccuracy. Another consequence of medication errors is that it leads to decreased patients' satisfaction and a growing lack of trust in the healthcare system (Rodziewicz, et al., In: StatPearls, Treasure Island (Fl.): StatPearls Publishing, 2024, https://www.ncbi.nlm.gov>books>NBK499956).

Improvements for health care diagnosis have been described. (Topol, Science 2024, volume 383, issue 6681, https://doi.org/10.1126/science.adn9602; Committee on Diagnostic Error in Health Care; Board on Health Care Services; Institute of Medicine; The National Academies of Sciences, Engineering, and Medicine. Editors: Balogh, E.P.; Miller, B.T.; Ball, J.R. Improving Diagnosis in Health Care. National Academies Press-Washington D.C., 2015; Hammerling, Laboratory Medicine 2012, volume 43, pages 41-44). Immunoassays used in vitro diagnostic technology have the shortcoming that of entailing an inherently high frequency with which errors are made and, therefore, have the potential for inaccurate and misleading results susceptible to misinterpretation and/or diagnostic misapplication by clinicians (Ismail, Clinical Medicine (London) 2017, volume 17, pages 329-332; Terato et al., Vaccine 2016, volume 34, pages 4643-4644). Patient safety in diagnosis is of paramount importance to avoid harm to patients (Shah et al., Journal of American Medical Society 2022, volume 327, issue 24, pages 2391-2392).

Two-dimensional technologies, such as affinity-capture-enrichment-separation capillary electrophoresis-mass spectrometry, particularly for the analysis of medium-to-low abundant proteins/peptides, glycoproteins/glycopeptides, in biological samples have been described (Guzman et al., International Journal of Translational Medicine 2024, volume 4, issue 2, pages 309-333; Guzman et al., Journal of Chromatography A 2023, volume 1704, https://doi.org/10.1016/j.chroma.2023.464109; Guzman et al., 2022, Research Features; doi: 10.26904/RF-141-2652756006; Guzman et al., Biomolecules 2021, volume 11, issue 10, https://doi.org/10.3390/biom11101443; Halvorsen et al., Analytica Chimica Acta 2021, volume 1182, https://doi.org/10.1016/j.aca.2021.338714; Guzman et al., Biomedicines 2020, volume 8, issue 8, https://doi.org/10.3390/biomedicines8080255; Palstrøm et al., International Journal of Molecular Sciences 2020, volume 21, issue 16, https://doi.org/10.3390/ijms21165903; Shao et al., Analytica Chimica Acta 2020, volume 1134, pages 1-9; Phillips et al., Electrophoresis 2013, volume 34, pages 1530-1538; Garrido-Medina et al., Analytica Chimica Acta 2014, volume 820, pages 47-55; Zhang et al., RSC Advances 2018, volume 8, 4063; pages 4063-4071; Seger at al., Clinical Biochemistry 2020, volume 82, pages 2-11; Neubert et al., Clinical Chemistry 2020, volume 66, issue 2, pages 282-301; Bringans et al., Clinical Proteomics 2020, volume 17, https://doi.org/101186/s12014-020-09302-w). Conventional affinity-capture-enrichment-separation technologies coupled to powerful detectors are useful to obtain accurate and sensitive determination of biomarkers. Conventional affinity-capture-enrichment-separation technologies have the shortcoming that the cost to maintain this advanced instrumentation is high.

Capillary electrophoresis that incorporate methods and systems for analyzing sample components in simple or complex mixtures, using one or more capillaries to increase throughput, and integrating sample preparation protocols have been described (Moring et al., U.S. Pat. No. 5,384,024; Hatch et al., U.S. Pat. No. 7,828,948; Amirkhanian et al., U.S. Pat. No. 8,460,531; McGivney et al., U.S. Pat. No. 9,159,537; Walton et al., U.S. Pat. No. 10,746,695; Yang et al., U.S. Pat. No. 11,933,759) but these instruments have the shortcoming of lacking on-line selective affinity-capture-enrichment preconcentration systems.

Significant improvements for an inexpensive and comprehensive biomarker testing system have been reported, based on the detection of multiple biomarkers simultaneously, and the re-used of a pre-concentrator affinity-capture device containing two or more affinity capture ligands for biomarkers identification and quantification (Guzman et al., 2024, International Journal of Translational Medicine 2024, volume 4, issue 2, pages 309-333). This method facilitates the frequent testing for biomarkers at low cost per assay. With the use of additional affinity ligands to capture internal standards the accuracy of the test is improved significantly, eliminating false results, and serves to monitoring the performance, aging and/or degradation of the affinity ligands within the analyte concentrator-microreactor device. Nevertheless, the preconcentrator affinity-capture device is part constituent of the miniaturized instrument described in the publication.

Based on the deficiencies described in the several publications previously discussed, there exists a need for an inexpensive, modular, hybrid, interchangeable support system including an analyte concentrator-microreactor device for attachment to a capillary electrophoresis cartridge-cassette, designed to be connected to a capillary electrophoresis instrument. The interchangeable support system is easily coupled and removed to-and-from a capillary electrophoresis instrument for providing inexpensive and rapid affinity capture, purification, enrichment, separation, identification, and characterization of a wide range of low- and high-molecular mass proteins and peptide biomarkers, and a large diversity of analytes found at a wide range of concentrations in simple and complex mixtures.

### BRIEF SUMMARY OF THE INVENTION

The present invention provides a modular, interchangeable, and integrated unitarian support system containing an analyte contractor-microreactor (ACM) device in which analyte concentration and or micro-reactions are carried out on on-line, in-situ location. The interchangeable support system includes a support platform having a main body with one or more apertures therein. A docking support cartridge cassette includes one or more pole supports extending from the docking support cartridge cassette and being respectively removably received in the one or more respective apertures of the main body of the support platform. The analyte concentrator-microreactor (ACM) device being removably coupled to the support platform. The interchangeable support system allows the analyte concentrator-microreactor (ACM) device to be expeditiously coupled to the docking support cartridge cassette. The analyte concentrator-microreactor (ACM) device can be installed and removed to and from the cartridge-cassette in a simple and rapid process and in a perfect fitting-docking alignment. The analyte concentrator-microreactor (ACM) device is secured to the support platform and localized at a convenient position to be connected to a transport capillary, in a staggered configuration, and to a separation capillary or channel, in a linear configuration. The interchangeable support system containing the ACM device and a separation capillary integrated to the cartridge-cassette is designed to be connected to a capillary electrophoresis apparatus for the affinity capture, purification, enrichment, separation, identification, and characterization of a wide range of low-and high-molecular mass proteins and peptide biomarkers, and a wide range of other biomarkers. Additionally, the interchangeable support system containing the ACM device can house an optical guiding system.

The analyte concentrator-microreactor (ACM) device can have three or four entrance/exit connection points; two are for connecting two portions of capillaries in the main body of the analyte concentrator-microreactor (ACM) device. A transport or sample introduction capillary is primarily used as a passage to introduce a separation buffer, a sample to be tested with or without derivatization, a plug of a tagging chromophore when needed, and a plug of an elution buffer or solution, in a linear direction, from an inlet side to an outlet side or port of the transport or sample introduction capillary. A separation capillary is used to separate sample components that have been bound to and eluted from a matrix of the analyte concentrator-microreactor (ACM) device. In one embodiment, two other entrance/exit connecting points are transport tubes or passages can be used for introducing the sample, in an orthogonal direction, from the entrance side or port of a lateral wall of the analyte concentrator-microreactor (ACM) device passing through the matrix of the analyte concentrator-microreactor (ACM) device and exiting on an exit side of the lateral wall of the analyte concentrator-microreactor (ACM) device as described for example in U.S. Pat. Nos. 7,329,388; 9,146,234; 9,696,299; 10,408,789; 11,740,204 and 12,228,545 hereby each incorporated by reference in entirety. In the embodiment of the present invention, the analyte concentrator-microreactor has only one exit port connecting the exit transport passage, carrying the excess amount of sample to be analyzed, and the wash and cleaning buffers to an outside container.

In one aspect, the present invention includes a matrix housing the affinity ligands. The matrix can be positioned within the inner space of the analyte concentrator-microreactor (ACM) device and can contain silica, agarose, and/or plastic beads to which one or more affinity ligands are immobilized or coupled, preferentially using a covalent chemical bond, but non-covalently attachment can be used as well. Frit structures can be used to retain the beads within the internal area of the analyte concentrator-microreactor (ACM) device, or capillaries with an internal dimension smaller than the beads. Magnetic beads containing affinity ligands can hold in place the beads using magnets to retain them in the cavity of the analyte concentrator-microreactor (ACM) device as described in for example Rashkovetsky et al., Journal of Chromatography A 1997, volume 781, issues 1-2, pages 197-204; Kaneta et al., Electrophoresis 2006, volume 27, issue 17, pages 3218-3223; Guzman et al., Electrophoresis 2008, volume 29, pages 3259-3278; Chen et al., Analytical Chemistry 2008, volume 8, issue 24, pages 9583-9588; Chen et al., Electrophoresis 2008, volume 29, pages 3414-3421; Morales-Cid et al., Analytica Chimica Acta 2013, volume 773, pages 89-96; Schejbal et al., Journal of Chromatography A 2016, volume 1437, pages 234-240. Alternatively, the one or more affinity ligands can be bound fritless directly to the inner wall of an internal area of the analyte concentrator-microreactor (ACM) device. The matrix can also be composed of a monolith porous structure materials, as described in for example Viklund et al., Chemistry of Materials 1996, Volume 8, issue 3, pages 744-750; Peterson et al., Analytical Chemistry 2002, volume 74, issue 16, pages 4081-4088; Svec, Journal of Chromatography B 2006, volume 841, issues 1-2, pages 52-64, forming a continuous solid phase made of one or more polymeric-based materials, or hydrogels, as described in for example Kellermann et al., Analyst 2023, volume 148, pages 4127-4137, or molecularly imprinted polymer, as described in for example Battista et al., Journal of Materials Chemistry B 2018, volume 6, pages 1207-1215, and serve to immobilize or attach to one or various types of affinity ligands. Flow control micro-valves can be used to regulate the flow of liquid, allowing or stopping the flow completely manually or by an electronic circuitry using an electronic operated micro-valve. The micro-valves are positioned at three or four entrance/exit ports of the corresponding connecting points of the capillaries or passages.

The present invention can have a separate, and independent side for sample introduction. In one embodiment, on a lateral side of the analyte concentrator-microreactor (ACM) device are positioned two entrance/exit ports, the sample is introduced through a large-bore sample transport capillary or passage, positioned in a staggered configuration, manually or using a miniaturized pump operated by an electronic circuitry as described for example in U.S. Pat. Nos. 7,329,388; 9,146,234; 9,696,299; 10,408,789; 11,740,204 and 12,228,545 hereby each incorporated by reference into this application. The pump can be a miniaturized vacuum pump, but a miniaturized pressure pump can be used as well.

In one aspect, the analyte concentrator-microreactor (ACM) device has a single port. The inlet side of the separation capillary can be used as a sample introduction side, and the sample can exit out from the one transport capillary of the ACM device. A single micro-valve can be used to control the fluid direction, and sample introduction, washes to remove excess amount of sample, release of the targeted biomarker bound to the matrix of the analyte concentrator-microreactor (ACM) device, and separation can be carried out an electronic circuitry control using the software operation of the instrument.

In one aspect, the present invention can use affinity-capture ligands to selectively or non-selectively capture one or more target analytes. One or a family of affinity ligands, or a combination of several different types of affinity ligands can be used. Suitable affinity ligands include antibodies, antibody fragments, nanobodies, lectins, aptamers, ankyrons, protein A/G, multimodal peptides, including many others that have high-affinity binding to one or more moieties of another molecule. These agents can act primarily as selective capture molecules of targeted analytes or biomarkers, serving as preanalytical concentrators, and can effectively and simultaneously serve as a clean-up process in removing excess amount of non-targeted analytes.

In one aspect of the present invention, the analyte concentrator-microreactor (ACM) device can be used as a microreactor that permits the performance on-line of chemical and/or biochemical reactions, such as enzymes immobilized to the matrix or within the inner wall of the analyte concentrator-microreactor (ACM) device to cleave proteins, nucleic acids or other larger polymeric biomolecules to generate smaller biochemical units. Also, cells, organelles or cellular receptors can be entrapped, encapsulated, or immobilized within the analyte concentrator-microreactor (ACM) device to perform complex organ-level biological reactions used for drug discovery and toxicology testing as an alternative to animal models (organ-on-a-chip/microfabrication and tissue engineering mimicking the structure and functionality of animal and human tissues) which are mediated by the conjugated actions of multiple enzymes and molecules to reflect human physiology in vitro as described in for example Ahmed, Biosensors and Bioelectronics: X 2022, volume 11, https://doi.org/10.1016/j.biosc.2022.100194; Ingber, Nature Review Genetics 2022, volume 23, pages 467-491; Leung et al., Nature Reviews Methods Primers 2022, volume 2, page 33, https://doi.org/10.1038/s43586-022-00118-6; Patents in organoids and organs-on-chips, Nature Biotechnology 2018, volume 36, issue 7, page 591; https://technology.nasa.gov/patent/MSC-TOPS-54. The analyte concentrator-microreactor (ACM) device is an advantageous platform to perform metabolism and/or bioactivity studies in miniaturized spaces. Biosynthesis and biocatalysis can be performed in a reduced space using natural or synthetic analogues of cellular organelles. Microreactors utilize small internal dimensions or diameters, for example on scale from 10 to 250 micrometers, to manipulate and control fluids in a controlled microenvironment. A typical example performed in a microreactor is proteolysis, where a proteolytic enzyme such as trypsin is immobilized to the bead or matrix of the ACM device, or directly onto the internal surface of the device, and cleaves a larger protein into small constituent peptides. A small time of incubation within the ACM device such of about 5 to about 30 minutes is usually allowed under optimal conditions for maximum cleavage of the protein with incubation temperatures of about 20 to 60 degrees Celsius, with some exceptions of enzymes that have evolved to operate below or about these temperatures as described in for example Arcus et al., Current Opinion in Structural Biology 2020, volume 65, pages 96-101.

In one aspect, the interchangeable supported platform to be mounted on a cartridge-cassette, including the analyte concentrator-microreactor (ACM) device, includes a supplementary area of an extension arm to attach an external optic unit. The extension arm of the support platform can guide and position a portion of the separation capillary including a window. The window of the separation cavity can be formed by stripping of a portion of a polymeric coating that protects the fused-silica capillary from breaking. The window positioned in the extension of the support platform can be aligned with a detection alignment system of the capillary electrophoresis instrument to allow monitoring of separated components of the sample and obtaining a corresponding read-out providing a peak area for each peak at a certain separation time. The interchangeable platform can expeditiously facilitate the installment of a separation capillary including a window in a ready-to-use cartridge-cassette-ACM device. The interchangeable support system provides a convenient design permit to prepare in advance multiple ready-to-use interchangeable platforms that can be kept at an appropriate temperature for prolonged storage. The ready-to-use interchangeable platforms can be transported from one city to another without altering efficiency and is able to do tasks successfully. Each interchangeable support system can have different sizes and lengths of capillary and different chemistries bonded to the matrix of the analyte concentrator-microreactor (ACM) device.

The present invention can be used to attach to the bead or matrix a universal affinity capture ligand to be designed to attract selectively an antibody, an aptamer, or another corresponding “bait” for trapping a targeted biomarker of interest. The bonding of the trapping bait can be designed for covalently or non-covalently attachment. An elution plug can contain an elution buffer or solution only for elution purposes, or an elution solution containing a fluorescent tagging chromophore to simultaneously elute the captured biomarker of interest and labeled the biomarker with an appropriate chromophore.

The present invention to connect the interchangeable support platform, containing an ACM device and mounted to a cartridge-cassette having an appropriate separation capillary, as described in for example the User Manual, Agilent 7100 Capillary Electrophoresis System, 2009-2019, https://www.agilent.com/cs/library/usermanuals/public/7100_CE_System_User_Manual.pdf; https://www.agilent.com/cs/library/catalogs/public/5991-5623EN.pdf, to a capillary electrophoresis instrument can be used for the affinity capture, purification, enrichment, separation, identification, and characterization of a wide range of low-and high-molecular mass proteins and peptide biomarkers, and a large diversity of analytes found at a wide range of concentrations in simple and complex chemical-biochemical mixtures, including cellular and subcellular entities as well as vesicles and micro-nanoparticulate matter.

The invention will be more fully described by reference to the following drawings.

### BRIEF DESCRIPTION OF THE SEVERAL VIEWS OF THE DRAWING(S)

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a perspective view of a support platform in accordance with the teachings of the present invention.

FIG. 2 is a top view of the support platform shown in FIG. 1.

FIG. 3 is a bottom view of the support platform shown in FIG. 1.

FIG. 4 is a perspective view of pole supports and a docking support mounted to the support platform.

FIG. 5 is a bottom view of FIG. 4.

FIG. 6 is a top view of FIG. 4.

FIG. 7 is a perspective view of pole supports and a docking support mounted to the support platform and including a retainer body.

FIG. 8 is a perspective view of an interchangeable support system including an analyte concentrator-microreactor device attached to a capillary electrophoresis cartridge-cassette and coupled to an exit transport capillary and a separation capillary.

FIG. 9 is a top view of FIG. 8.

FIG. 10 is bottom view of FIG. 8.

FIG. 11 is a right side view of FIG. 8.

FIG. 12 is a left side view of FIG. 8.

FIG. 13 is a perspective view of a support platform in accordance with the teachings of the present invention including extension arm containing channel to guide a separation capillary for proper alignment.

FIG. 14 is a top view of FIG. 13.

FIG. 15 is a bottom view of FIG. 13.

FIG. 16 is a front end view of FIG. 13.

FIG. 17 is a rear end view of FIG. 13.

FIG. 18 is a right side view of FIG. 13.

FIG. 19 is a left side view of FIG. 13.

FIG. 20 is a perspective view of a capillary electrophoresis cartridge-cassette coupled to an interchangeable support platform and an ACM device coupled to the interchangeable support platform and including a separation capillary.

FIG. 21 is a top view of FIG. 20.

FIG. 22 is a bottom view of FIG. 20.

FIG. 23 is a right side view of FIG. 20.

FIG. 24 is a left side view of FIG. 20.

FIG. 25 is a perspective view is a perspective view of a support platform in accordance with the teachings of the present invention including extension arm containing channel to guide a separation capillary for proper alignment and a detector device and a received capillary alignment interface tool.

FIG. 26 is a top view of FIG. 25.

FIG. 27 is a bottom view of FIG. 25.

FIG. 28 is a front end view of FIG. 25;

FIG. 29 is a rear end view of FIG. 25.

FIG. 30 is a right side view of FIG. 25.

FIG. 31 is a left side view of FIG. 25.

FIG. 32 is a perspective view of a capillary electrophoresis cartridge-cassette coupled to an interchangeable support platform and an ACM device coupled to the interchangeable support platform separately and independently and including s separation capillary and a received capillary insertion tool.

FIG. 33 is a top view of FIG. 32.

FIG. 34 is a right side view of FIG. 32.

FIG. 35 is a left side view of FIG. 32.

FIG. 36 is a bottom view of a detection alignment system platform positioned at an outlet of a separation capillary.

FIG. 37 is a perspective view of the detection alignment system platform.

FIG. 38 is a top view of FIG. 37.

FIG. 39 is a front end view of FIG. 37.

FIG. 40 is a rear end view of FIG. 37.

FIG. 41 is a right side view of FIG. 37.

FIG. 42 is a left side view of FIG. 37.

### DETAILED DESCRIPTION OF THE INVENTION

Reference will now be made in greater detail to a preferred embodiment of the invention, an example of which is illustrated in the accompanying drawings. Wherever possible, the same reference numerals will be used throughout the drawings and the description to refer to the same or like parts.

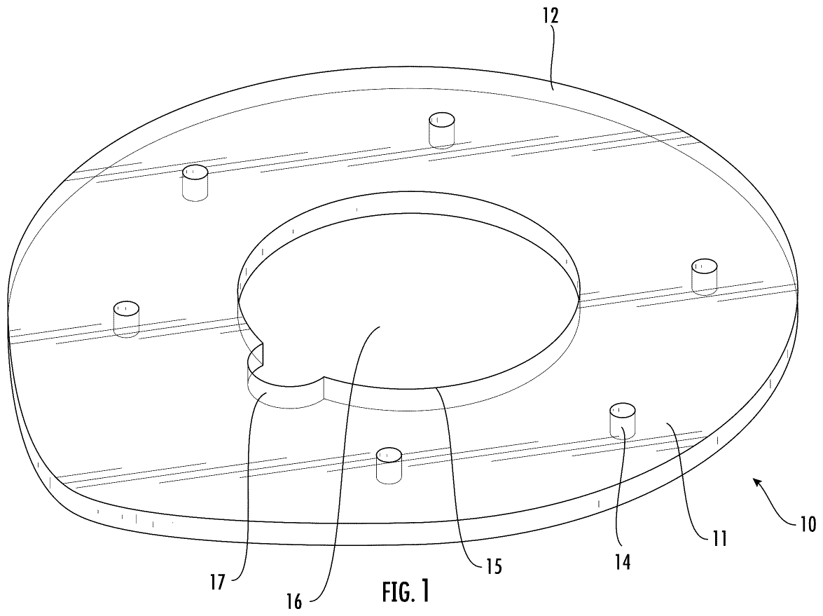

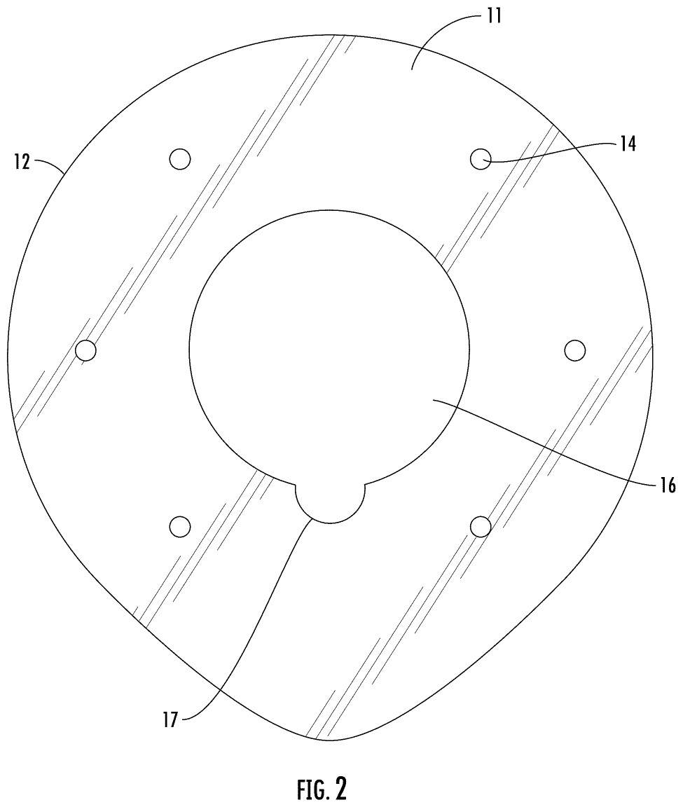

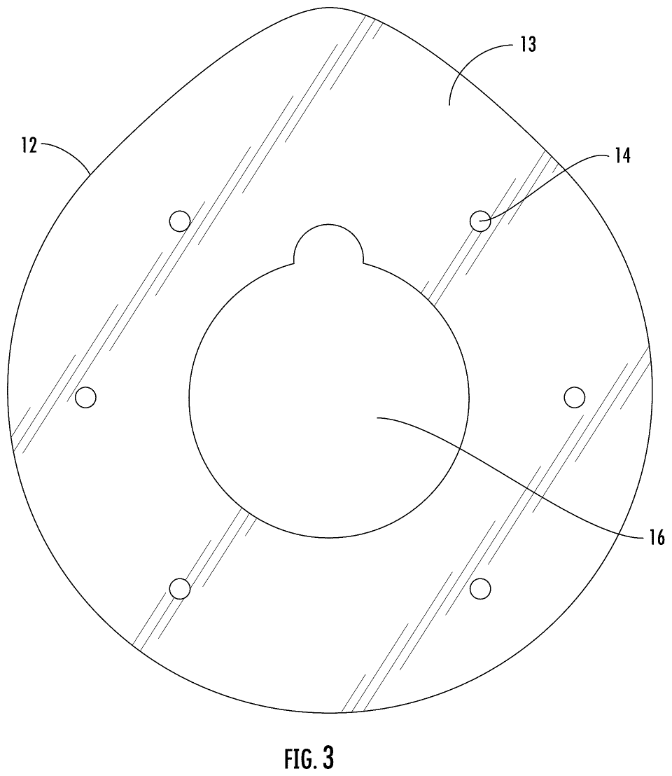

FIGS. 1-3 illustrate support platform 10 in accordance with the teachings of the present invention. Support platform 10 is portable and interchangeable with one or more docking support cartridge cassettes as described in more detail below. Support platform 10 comprises main body 12 having top surface 11 and bottom surface 13. Apertures 14 extend through main body 12 from top surface 11 to bottom surface 13. Central opening 16 extends through main body 12 at central portion 15 of main body 12. Opening extension 17 can extend from central opening 16.

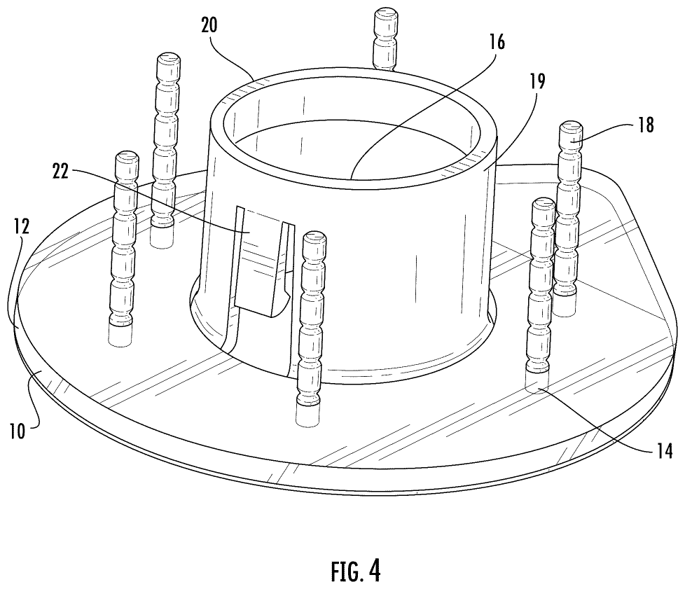

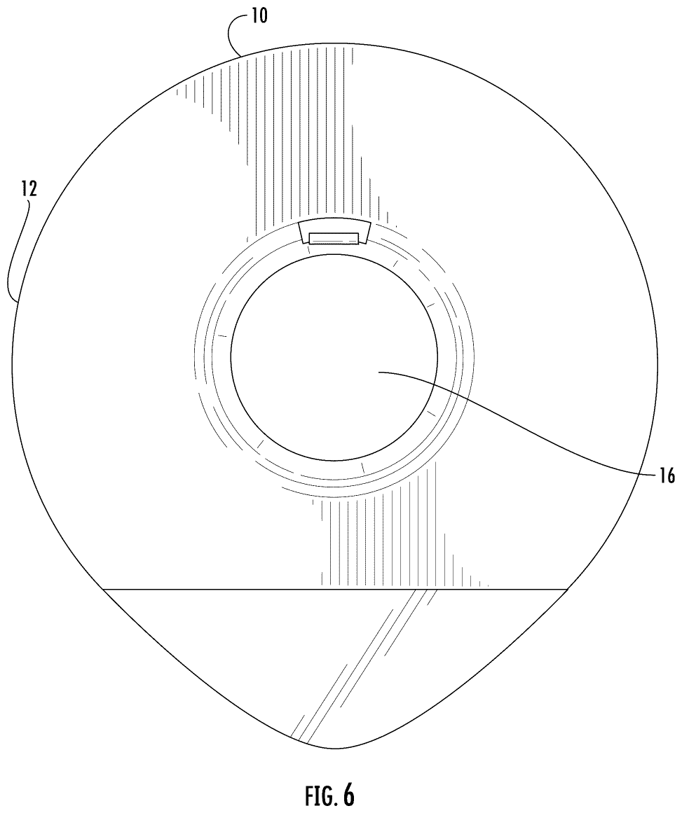

FIGS. 4-6 illustrate docking support cartridge cassette 20 removably mounted to support platform 10. One or more pole supports 18 extend from docking support cartridge cassette 20 and are received in respective apertures 14 of main body 12 of support platform 10 as shown in FIG. 4. One or more pole supports 18 can be mounted to docking support cartridge cassette 20. For example, one or more pole supports 18 can be glued to docking support cartridge cassette 20. It will be appreciated that one or more pole supports 18 can be retrofitted to a conventional cartridge cassette. Alternatively, one or more pole supports 18 can be integral with docking support cartridge cassette 20.

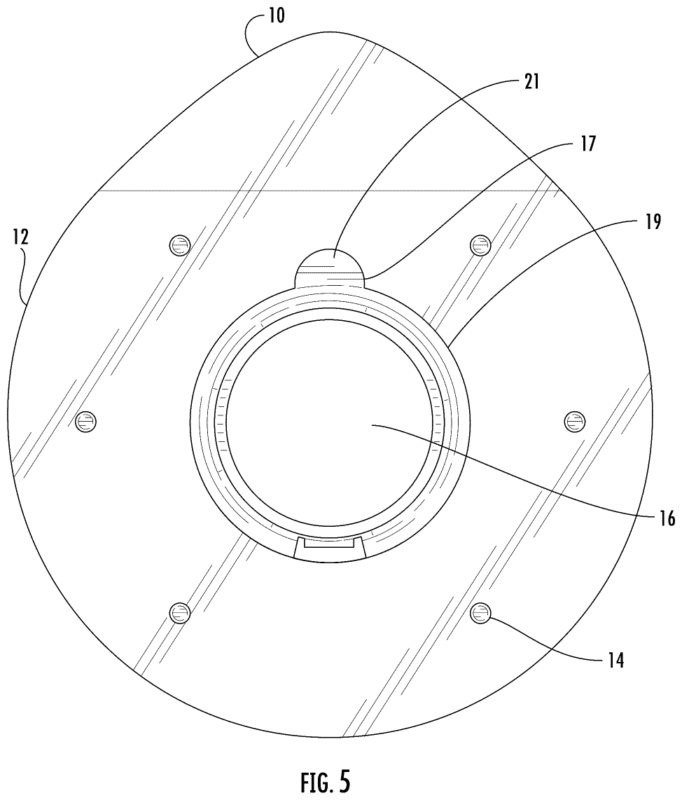

Docking support cartridge cassette 20 can include body 19. Body 19 can be removably or permanently attached to docking support cartridge cassette 20. In one embodiment, body 19 is integral with docking support cartridge cassette 20. Body 19 is received in central opening 16 of main body 12 of support platform 10. Body 19 can have a cylindrical tube shape. Protuberance 21 extends from body 19 as shown in FIG. 5. The shape of body 19 and protuberance 21 correspond to the shape of central opening 16 and opening extension 17 to provide complimentary docking alignment and optimal fitting between docking support cartridge cassette 20 and support platform 10. It will be appreciated that the shape of central opening 16 and opening extension 17 can be varied and the corresponding shape of body 19 and protuberance 21 can be varied to a similar shape.

Referring to FIG. 4, protrusion 22 can be formed on body 19 of docking support cartridge cassette 20. An example docking support cartridge cassette 20 is part of Agilent 7100 or Agilent 1600 Capillary Electrophoresis Systems, manufactured by Agilent Technologies.

In one embodiment, after receipt of one or more pole supports 18 of docking support cartridge cassette 20 in respective apertures 14 of main body 12 of support platform, retainer body 25 can be received over one or more pole supports 18 as shown in FIG. 7. Retainer body 25 includes opening 27. Pole support 18 is received in opening 27 of retainer body 25. Side panels 28 extend from retainer body 25. Side panels 28 can include aperture 29. Aperture 29 can receive and support a capillary as described in more detail below.

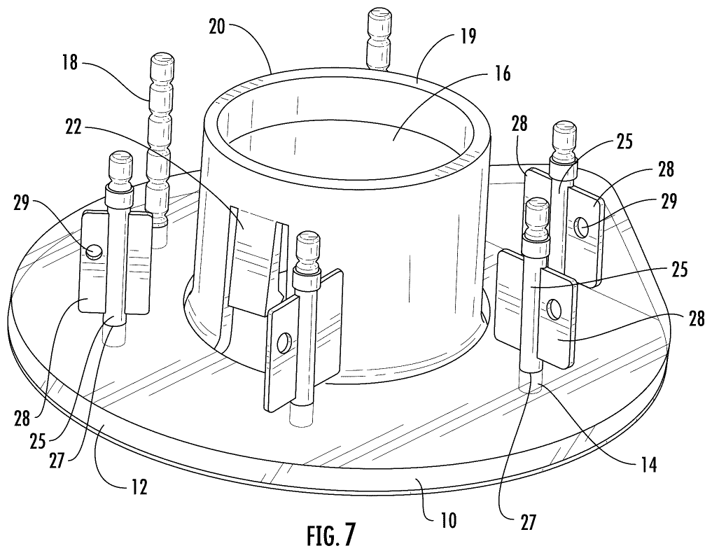

FIG. 8 illustrates interchangeable support system 100 including analyte concentrator-microreactor (ACM) device 30 attached to docking support capillary electrophoresis cartridge-cassette 31. Analyte concentrator-microreactor (ACM) device 30 is removably coupled to support platform 10. Analyte concentrator-microreactor (ACM) device 30 can be coupled to support platform 10 using both pole support 32 and screw 34. Pole support 32 extends from docking support capillary electrophoresis cartridge-cassette 31 and is received in aperture 14 of main body 12 of support platform 10. Pole support 32 extends through opening 33 in analyte concentrator-microreactor (ACM) device 30. Screw 34 can couple analyte concentrator-microreactor (ACM) device 30 to main body 12 of support platform 10.

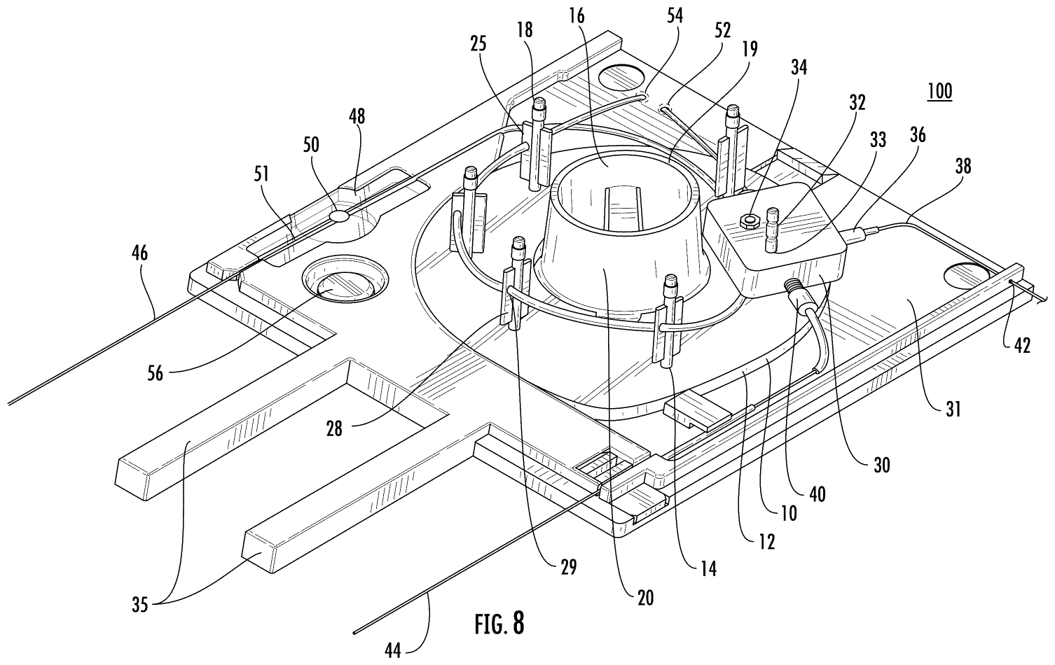

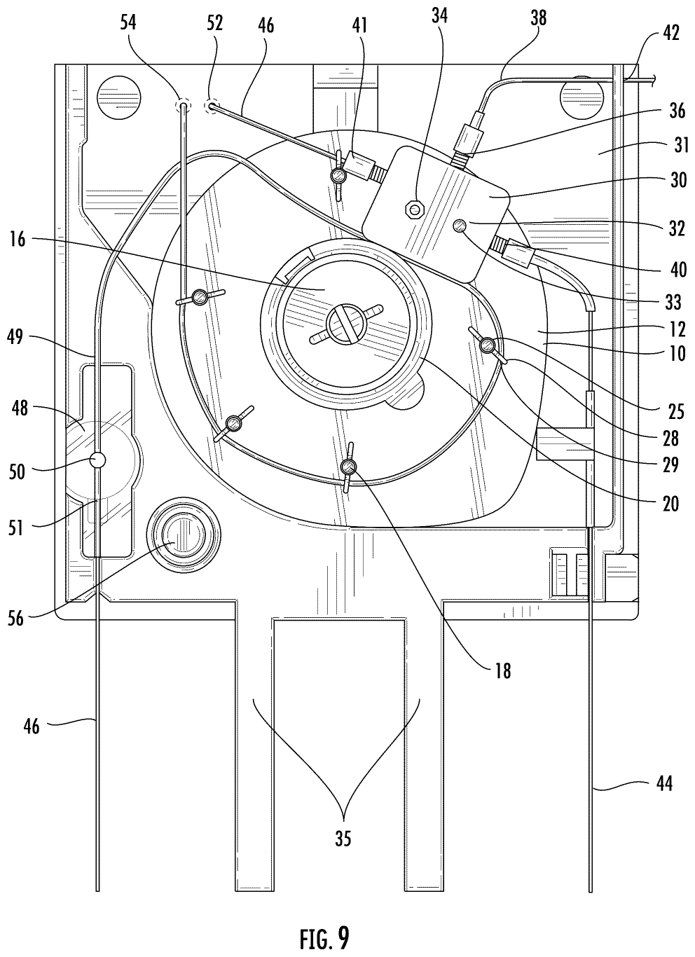

Exit connector 36 attaches analyte concentrator-microreactor (ACM) device 30 to transport capillary 38 as shown in FIG. 9. Side connector 40 and side connector 41 attach a respective transport or sample introduction capillary 44 and separation capillary 46 to analyte concentrator-microreactor (ACM) device 30. Transport or sample introduction capillary 44 is a portion of the capillary where a sample and/or buffer is introduced. A preferred location of analyte concentrator-microreactor (ACM) device 30 is near an inlet of transport or sample introduction capillary 44. Separation capillary 46 is a portion of the capillary where one or more components in the sample are separated. Separation capillary 46 passes through aperture 29 of each of side panels 28 as shown in FIG. 8. Transport capillary 38 exits docking support capillary electrophoresis cartridge-cassette 31 through opening 42. Separation capillary 46 extends through opening 52 and opening 54 in docking support capillary electrophoresis cartridge-cassette 31 to a micro-valve system localized on the rear of docking support capillary electrophoresis cartridge-cassette 31 as described below.

Detection alignment system platform 48 is positioned at outlet end 49 of separation capillary 46. Detection alignment system platform 48 contains channel 51 to guide separation capillary 46 for proper alignment. Separation capillary 46 includes window 50 where a beam of light of a detector (not shown) can be passed through to monitor individual selectively captured and enriched analytes which are separated along separation capillary 46. In one embodiment, separation capillary 46 has a surface coating of polyimide and a portion of the surface coating is removed by heat, chemical etching methods, UV or CO2 laser, or other methods, as described in for example Wang et al., Journal of Chromatography A 2024, volume 1736, https://doi.org/10.1016/j.chroma.2024.465395, to form window 50. Capillary insertion tool housing structure 56 can receive capillary alignment interface tool (not shown) to proper positioning and align the clear surface of the capillary or window 50.

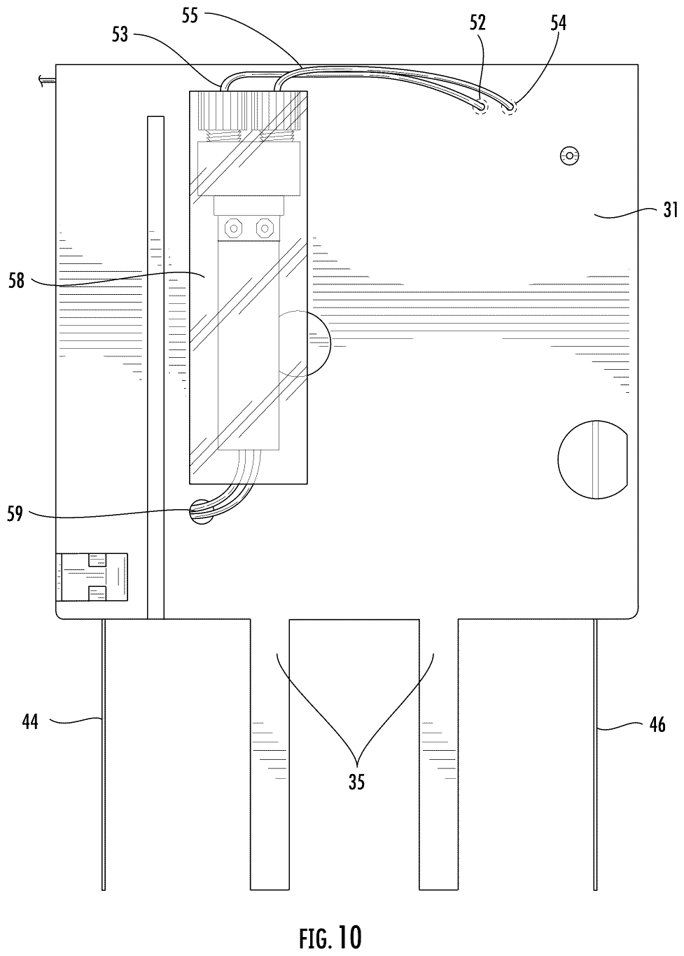

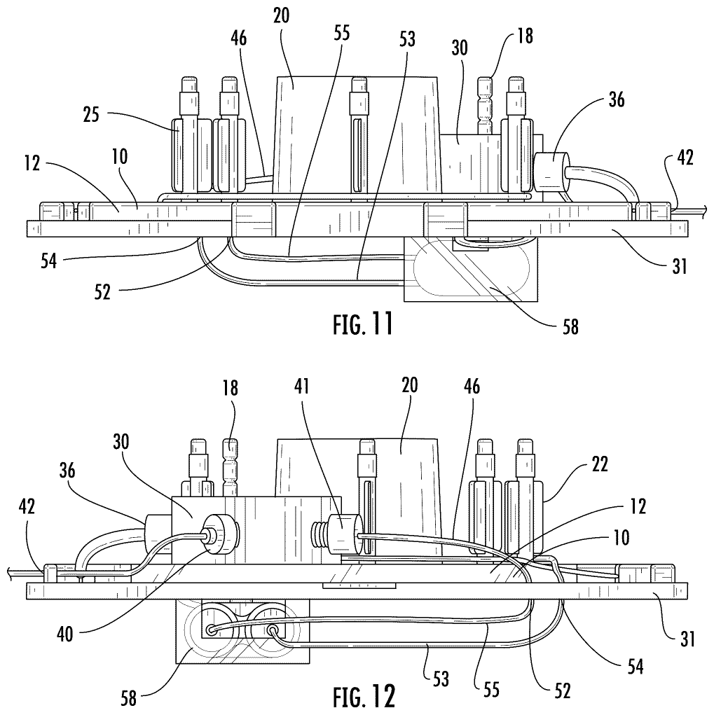

FIGS. 10-12 illustrate docking support capillary electrophoresis cartridge-cassette 31 in which separation capillary 46 extends through hole 52 and hole 54 to respective connector tubes or capillaries 53 and 55 to electronically operated micro-valve 58 to control the direction of the various fluids used for sample enrichment, elution, separation and characterization. Electronic cables of micro-valve 58 exit docking support capillary electrophoresis cartridge-cassette 31 through hole 59.

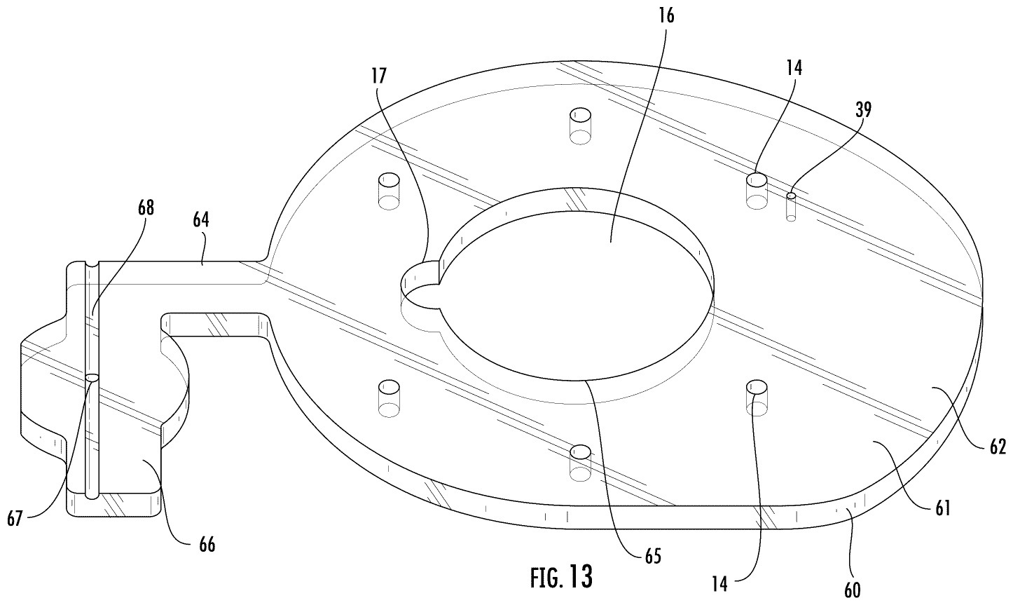

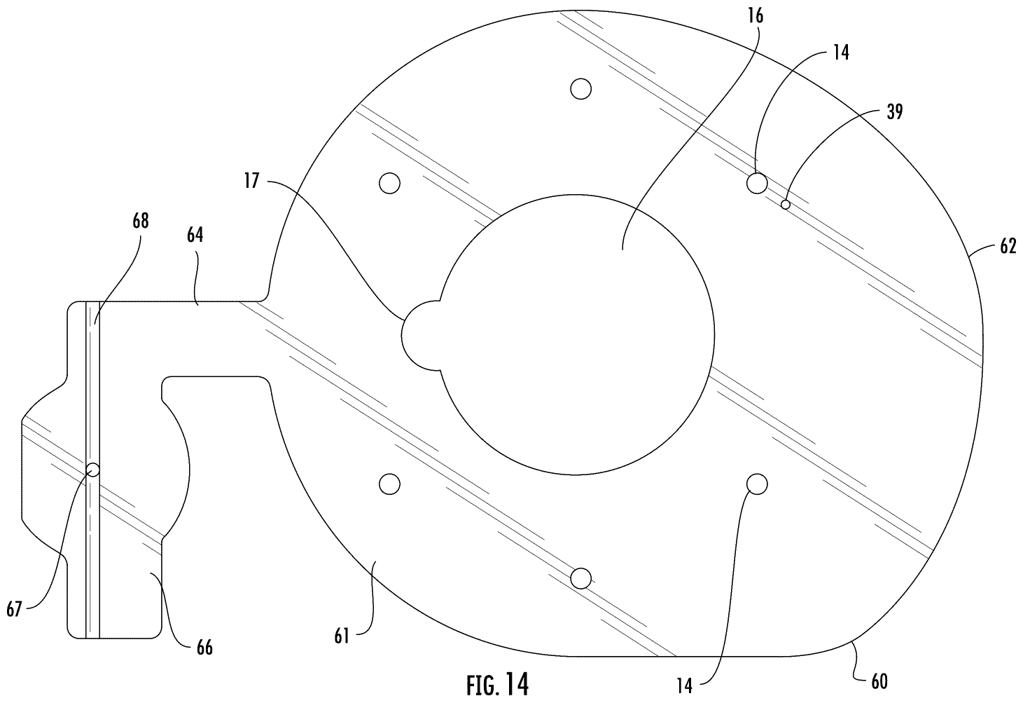

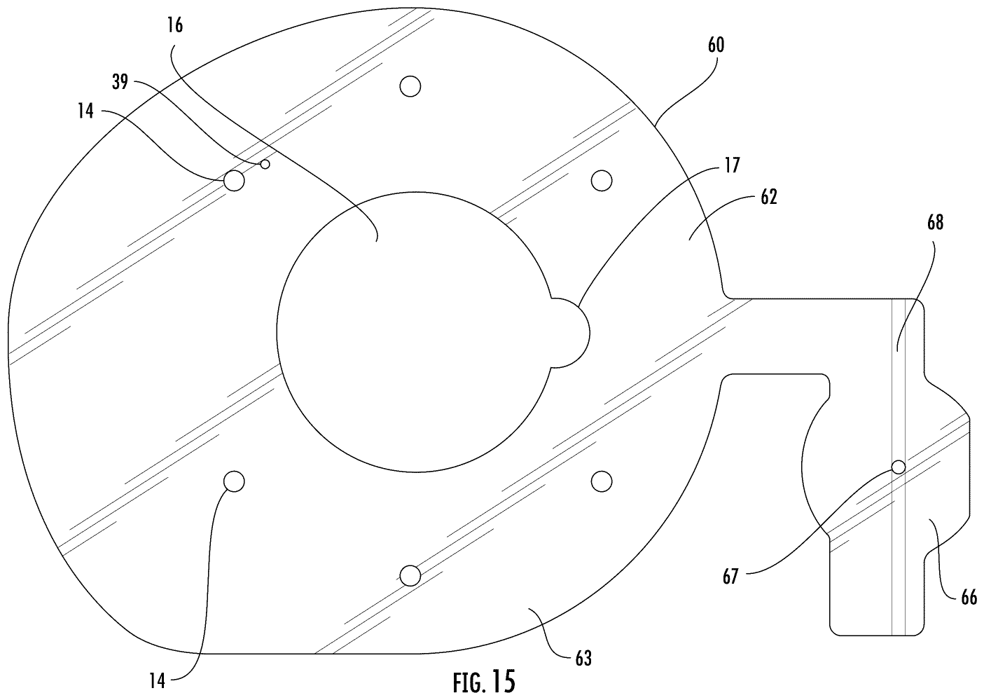

FIGS. 13-19 illustrate support platform 60 in accordance with the teachings of the present invention. Support platform 60 is portable and interchangeable with one or more docking support cartridge cassettes as described in more detail below. Support platform 60 comprises main body 62 as shown in FIG. 13. Main body 62 having top surface 61 as shown in FIG. 14 and bottom surface 63 as shown in FIG. 15. Apertures 14 extend through main body 62 from top surface 61 to bottom surface 63. Aperture 39 is positioned on top surface of main body 62 for receiving screw 34 (not shown). Central opening 16 extends through main body 62 at central portion 15 of main body 62. Opening extension 17 can extend from central opening 16.

Protrusion 64 extends from main body 62. Extension arm 66 extends from protrusion 64. Extension arm 66 contains channel 68 to guide separation capillary 46 for proper alignment. Channel 68 includes window area 67.

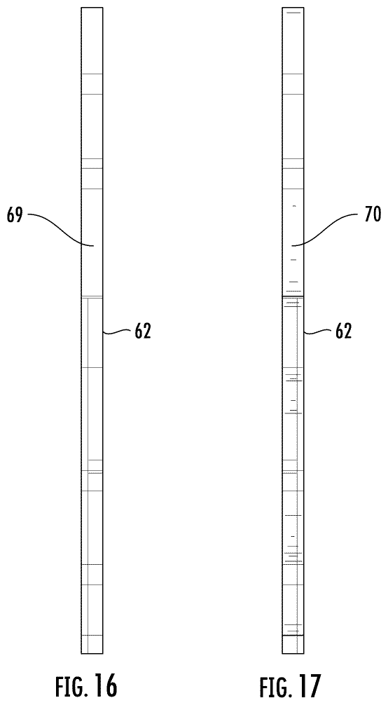

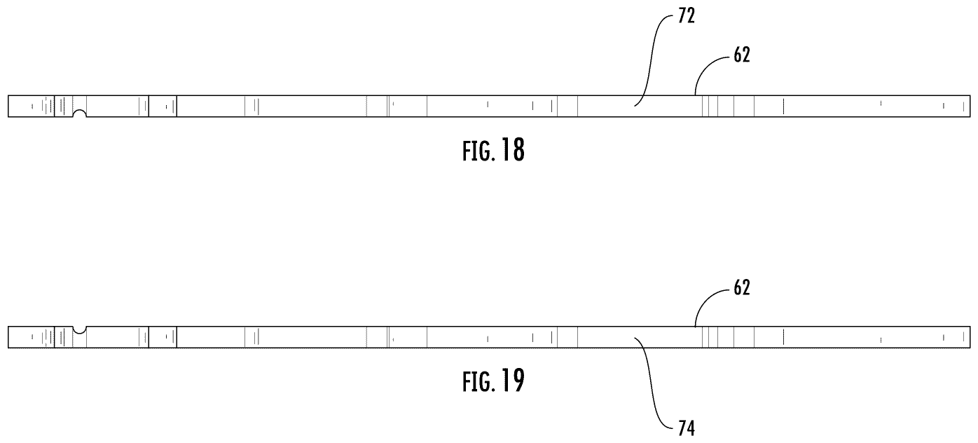

FIG. 16 illustrates front end 69 of main base 62. FIG. 17 illustrates rear end 70 of main base 62. FIG. 18 illustrates side 72 of main base 62. FIG. 19 illustrates side 74 of main base 62.

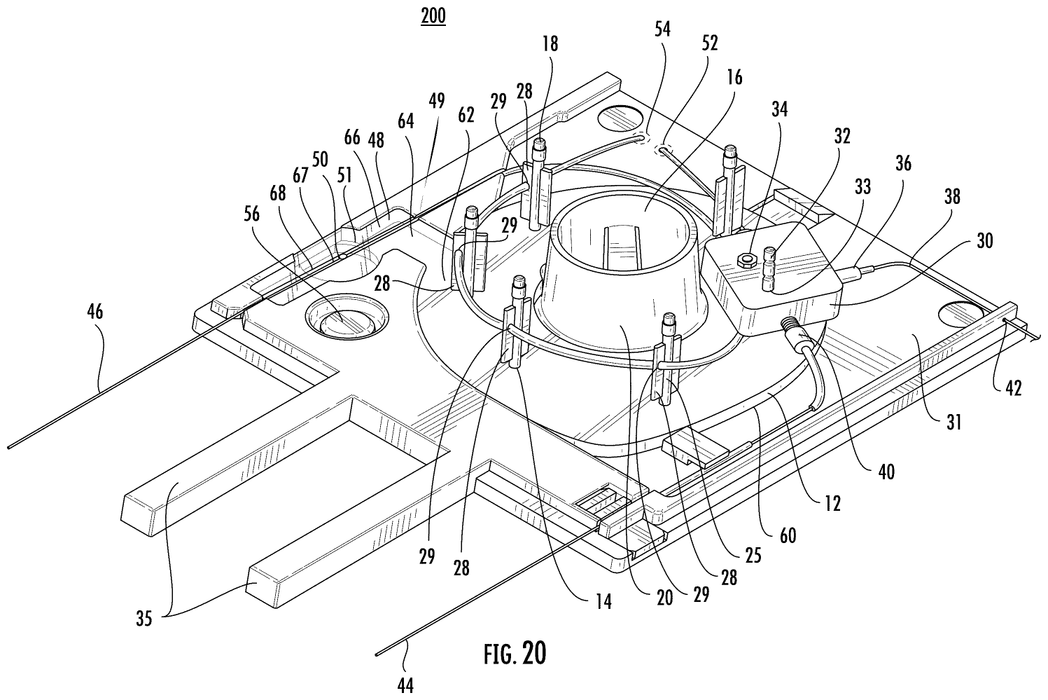

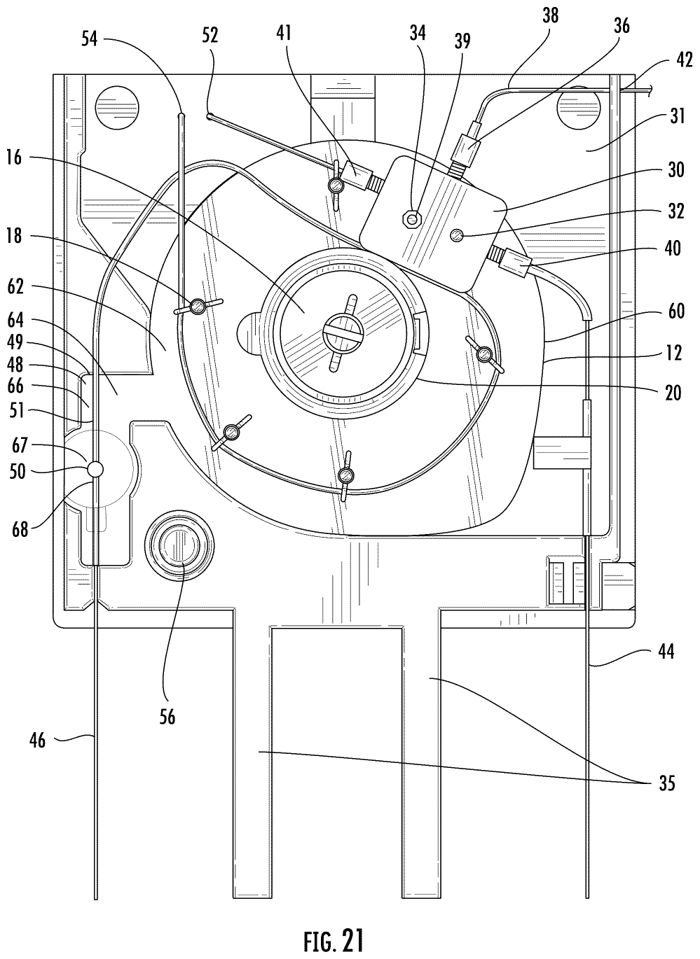

FIG. 20 illustrates interchangeable support system 200 including analyte concentrator-microreactor (ACM) device 30 attached to docking support capillary electrophoresis cartridge-cassette 31. Analyte concentrator-microreactor (ACM) device 30 is removably coupled to support platform 60. Analyte concentrator-microreactor (ACM) device 30 can be coupled to support platform 60 using both pole support 32 and screw 34. Pole support 32 extends from docking support capillary electrophoresis cartridge-cassette 31 and is received in aperture 14 of main body 12 of support platform 60. Pole support 32 extends through opening 33 in analyte concentrator-microreactor (ACM) device 30. Screw 34 is received in aperture 39 of main body 12 to couple analyte concentrator-microreactor (ACM) device 30 to main body 12 of support platform 60 as shown in FIG. 21.

Exit connector 36 attaches analyte concentrator-microreactor (ACM) device 30 to transport capillary 38. Side connector 40 and side connector 41 as shown in FIG. 21 attach a respective transport or sample introduction capillary 44 and separation capillary 46 to analyte concentrator-microreactor (ACM) device 30. Transport or sample introduction capillary 44 is a portion of the capillary where a sample and/or buffer and a plug of elution buffer or solution is introduced. Separation capillary 46 is a portion of the capillary where one or more components separated in the sample are received and detected. Analyte concentrator-microreactor (ACM) device 30 is designed to work in coordination with a capillary electrophoresis instrument for on-line concentration and analysis of one or a plurality of chemical and biochemical biomarkers, including cellular and subcellular entities and their internal and external contents, in biological fluids and various types of simple and complex matrices coordinated and sequential order for the affinity capture, purification, enrichment, separation, identification, and characterization of a wide range of low-and high-molecular mass proteins and peptide biomarkers, and a large diversity of analytes found at a wide range of concentrations in simple and complex chemical-biochemical mixtures, including cellular and subcellular entities as well as vesicles and micro-nanoparticulate matter. Analyte concentrator-microreactor (ACM) device analyte 30 connected to transport or sample introduction capillary 44 and to separation capillary 46 and to one or more micro-valves can be used to control the passing of fluids for a coordinated and sequential order for the affinity capture, purification, enrichment, separation, identification, and characterization of a wide range of low-and high-molecular mass proteins and peptide biomarkers, and a large diversity of analytes found at a wide range of concentrations in simple and complex chemical-biochemical mixtures, including cellular and subcellular entities as well as vesicles and micro-nanoparticulate matter. The integrated modular, hybrid support system can be replaced readily and efficiently and can perform on-line a variety of molecular interactions including preconcentration, biochemical, metabolic or bioactivity studies. Suitable concentrator-microreactor (ACM) devices have been described in U.S. Pat. Nos. 7,329,388; 9,146,234; 9,696,299; 10,408,789; 11,740,204 and 12,228,545 hereby each incorporated by reference into this application.

Separation capillary 46 passes through aperture 29 of each of side panels 28 as shown in FIG. 20. Transport capillary 38 exits docking support capillary electrophoresis cartridge-cassette 31 through opening 42 to an external container. Separation capillary 46 extends through opening 52 and opening 54 in docking support capillary electrophoresis cartridge-cassette 31 to a micro-valve system localized on the rear of docking support capillary electrophoresis cartridge-cassette 31 as described below. Support platform 60 includes protrusion 64 extending from main body 62. Extension arm 66 extends from protrusion 64. Extension arm 66 contains channel 68 to guide separation capillary 46 for proper alignment. Channel 68 includes window area 67 where a beam of the detector (not shown) can be passed-through window 50 of separation capillary 46 to monitor the individual selectively captured and enriched analytes that are separated along separation capillary.

Detection alignment system platform 48 is positioned at outlet end 49 of separation capillary 46. Detection alignment system platform 48 contains channel 51 to guide separation capillary 46 for proper alignment. Separation capillary 46 includes window 50 where a beam of light of a detector (not shown) can be passed through to monitor individual selectively captured and enriched analytes which are separated along separation capillary 46. In one embodiment, separation capillary 46 has a surface coating of polyimide and a portion of the surface coating is removed by heat, chemical etching methods, UV or CO2 laser, or other methods, forming a window or optical window as described for example in Wang et al., Journal of Chromatography A 2024, volume 1736, https://doi.org/10.1016/j.chroma. 2024.465395, to form window 50. Capillary insertion tool housing structure 56 can receive capillary alignment interface tool (not shown). Docking support capillary electrophoresis cartridge-cassette 31 has pole base extensions 35 to place and align docking support capillary electrophoresis cartridge-cassette 31 into a capillary electrophoresis instrument (not shown).

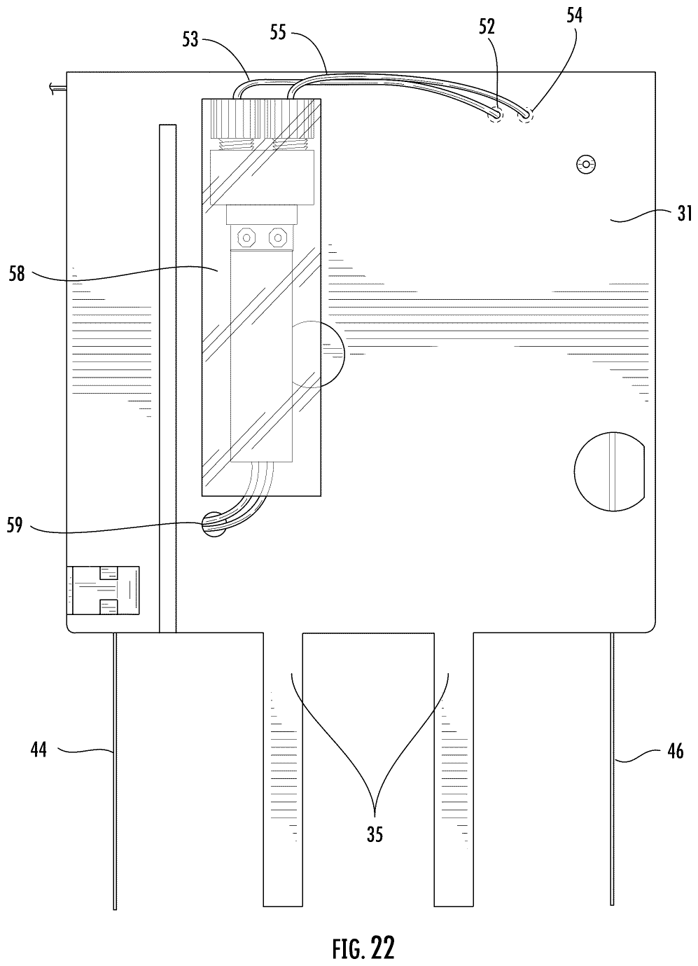

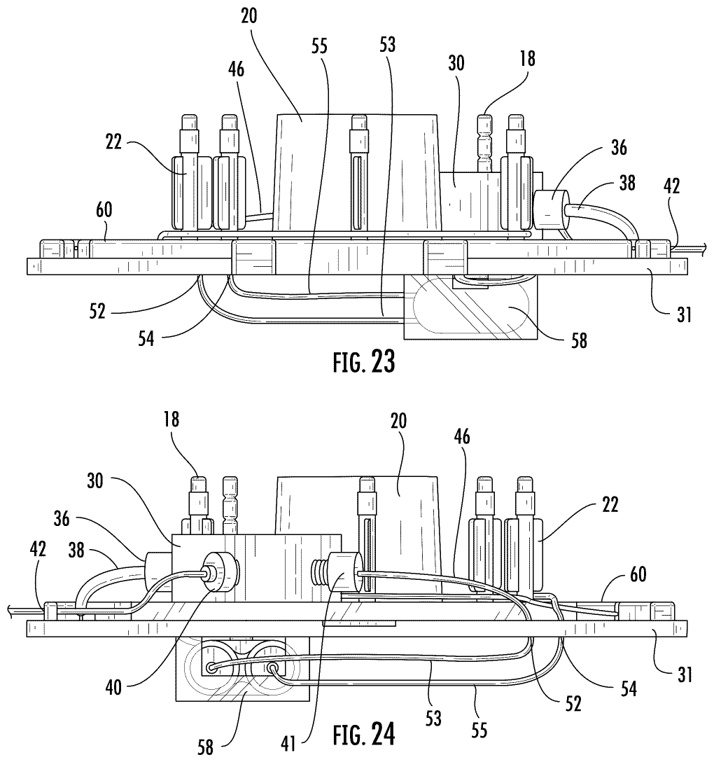

FIGS. 22-24 illustrate docking support capillary electrophoresis cartridge-cassette

31 in which separation capillary 46 extends through hole 52 and hole 54 to respective connector tubes or capillaries 53 and 55 to electronically operated micro-valve 58 to control the direction of the various fluids used for sample enrichment, elution, separation and characterization. Electronic cables of micro-valve 58 exit docking support capillary electrophoresis cartridge-cassette 31 through hole 59. Analyte concentrator-microreactor (ACM) device analyte 30 can be readily replaced to docking support capillary electrophoresis cartridge-cassette 31 to readily and efficiently perform on-line a variety of molecular interactions including preconcentration, biochemical, metabolic or bioactivity studies.

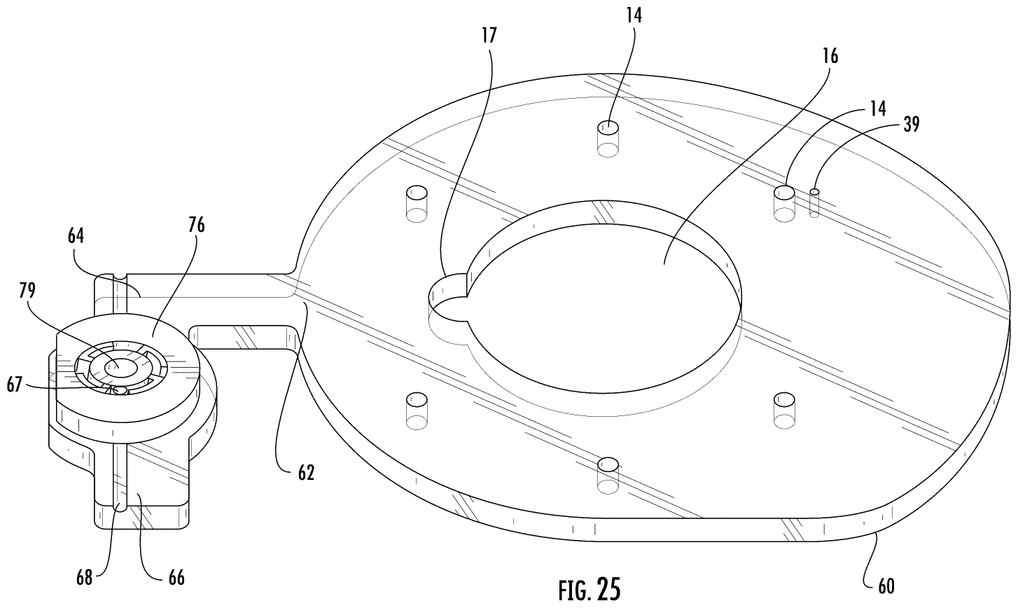

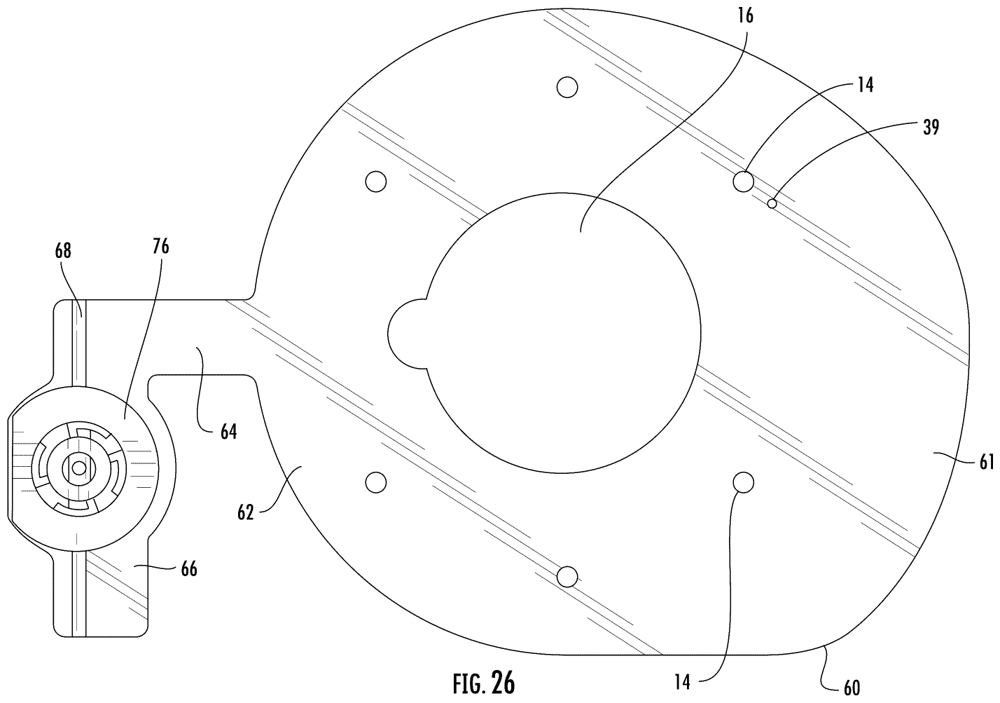

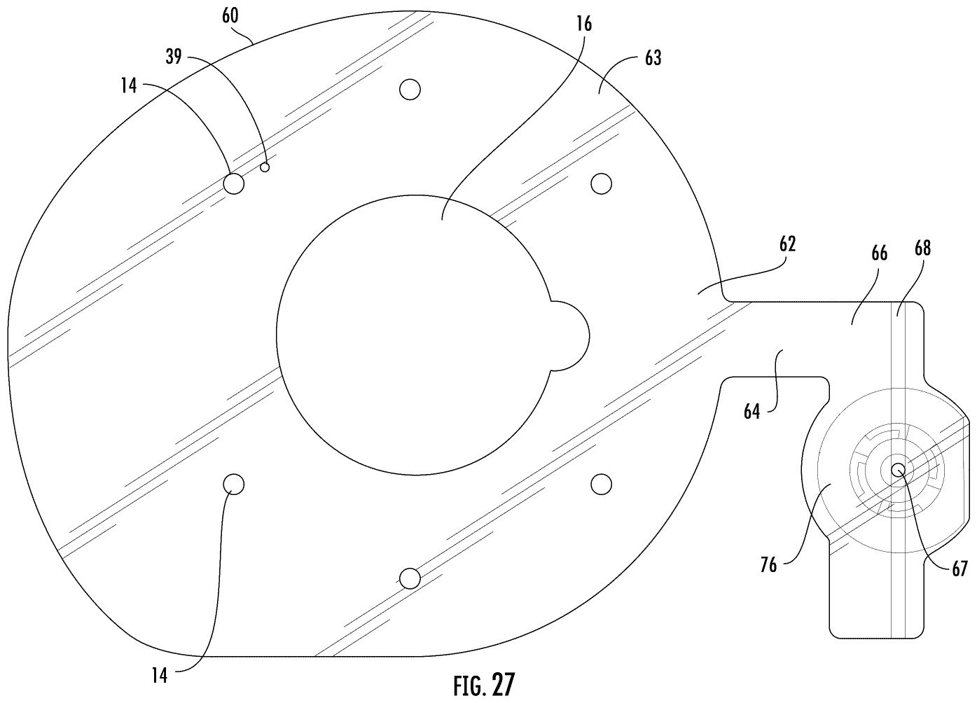

FIGS. 25-31 illustrate support platform 60 after receiving capillary alignment interface tool 76. Support platform 60 is portable and interchangeable with one or more docking support cartridge cassettes as previously described. Support platform 60 comprises main body 62 as shown in FIG. 25. Main body 62 having top surface 61 as shown in FIG. 26 and bottom surface 63 as shown in FIG. 27. Support platform 60 comprises main body 62 having top surface 61 and bottom surface 63. Apertures 14 extend through main body 62 from top surface 61 to bottom surface 63. Central opening 16 extends through main body 62. Opening extension 17 extends from central opening 16. Protrusion 64 extends from main body 62. Extension arm 66 extends from protrusion 64. Extension arm 66 contains channel 68 to guide separation capillary 46 for proper alignment. Channel 68 includes window area 67. Central portion 79 of capillary alignment interface tool 76 shown in FIG. 25 is placed and perfectly aligned in extension arm 66 of main body 62 for optimal passing of a beam of light from the detector unit (not shown) through window 50 of separation capillary 46 (not shown).

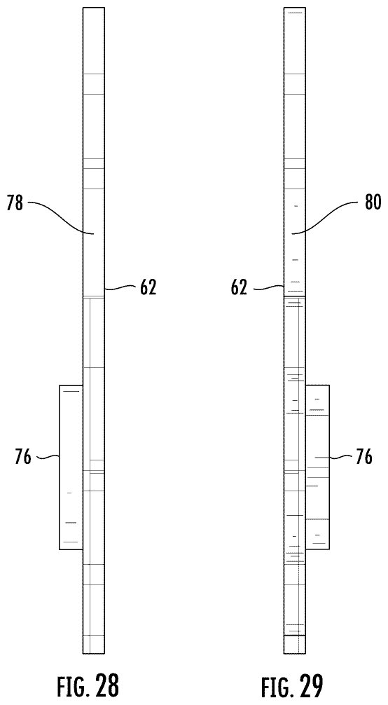

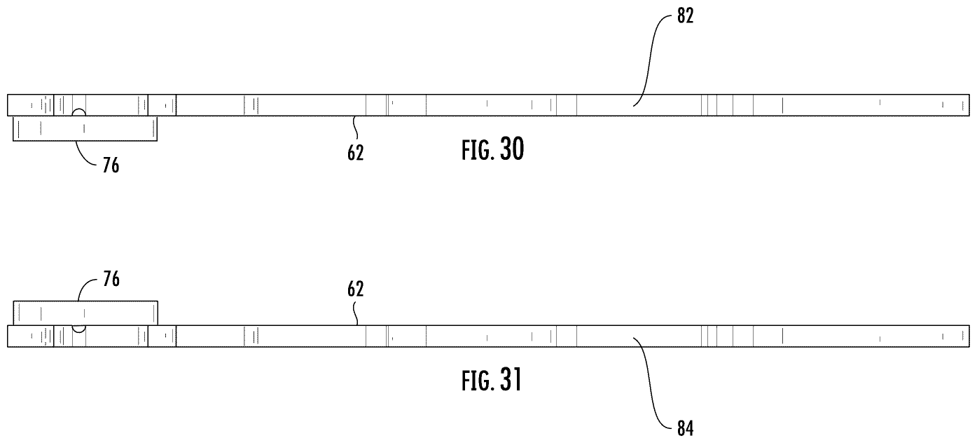

FIG. 28 illustrates front end 78 of main base 62 including received capillary alignment interface tool 76. FIG. 29 illustrates rear end 80 of main base 62 including received capillary alignment interface tool 76. FIG. 30 illustrates side 82 of main base 62 including received capillary alignment interface tool 76. FIG. 31 illustrates side 84 of main base 62 including received capillary alignment interface tool 76.

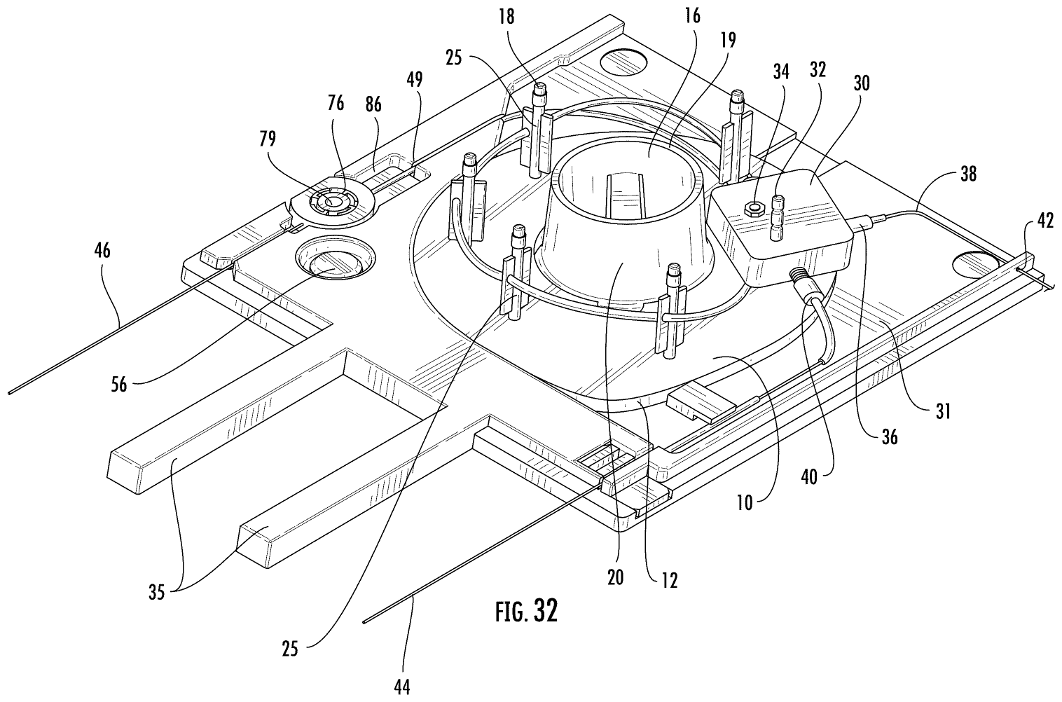

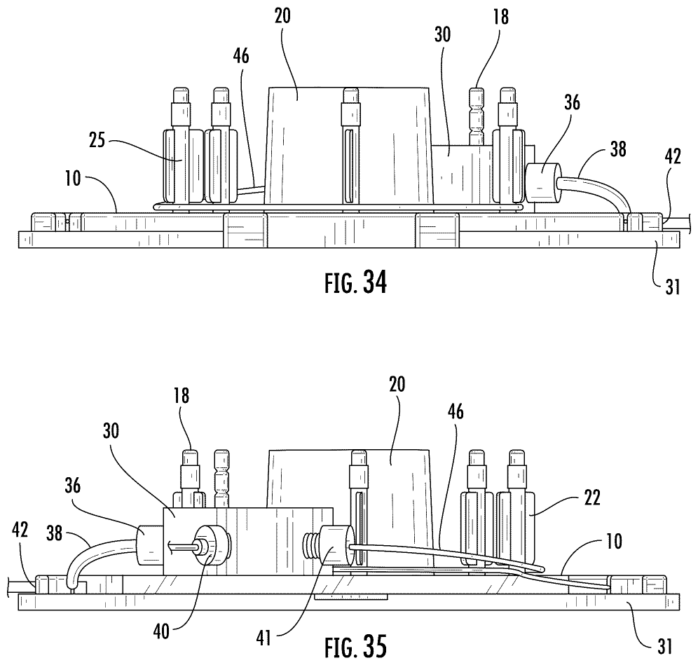

FIGS. 32-35 illustrate docking support capillary electrophoresis cartridge-cassette 31 coupled to support platform 10 and analyte concentrator-microreactor (ACM) device 30 coupled to support platform 10 and including transport or sample introduction capillary 44 and separation capillary 46 and including received capillary alignment interface tool 76.

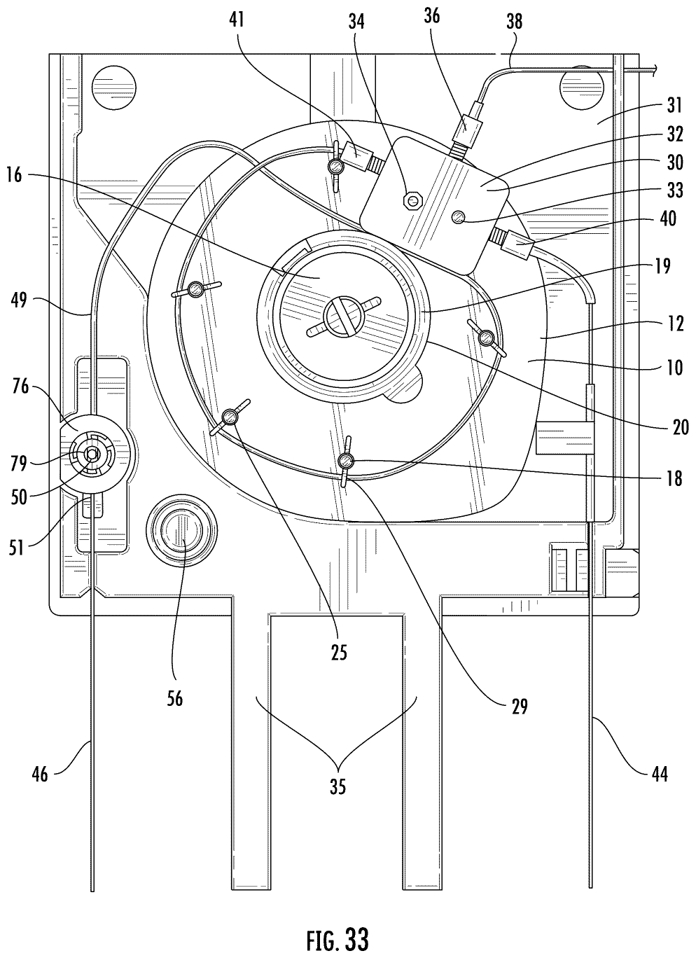

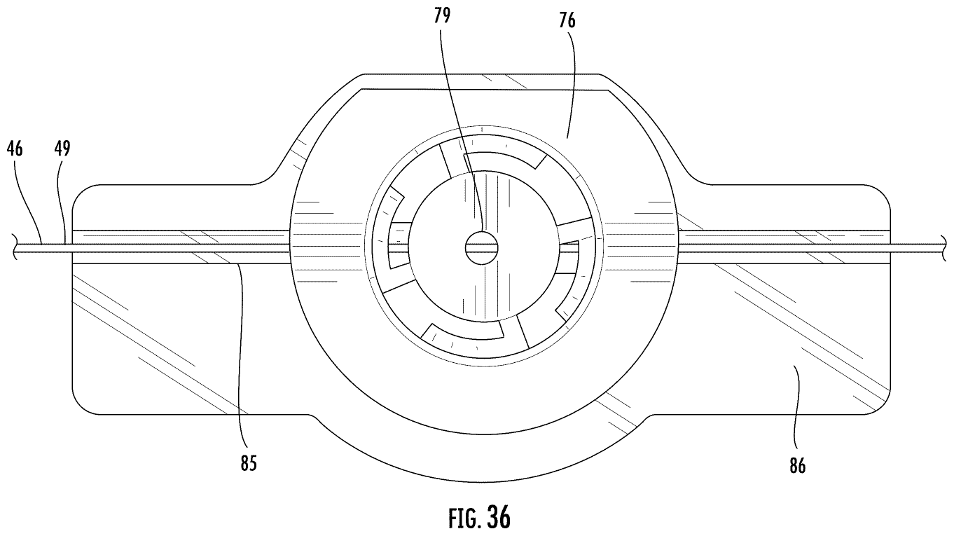

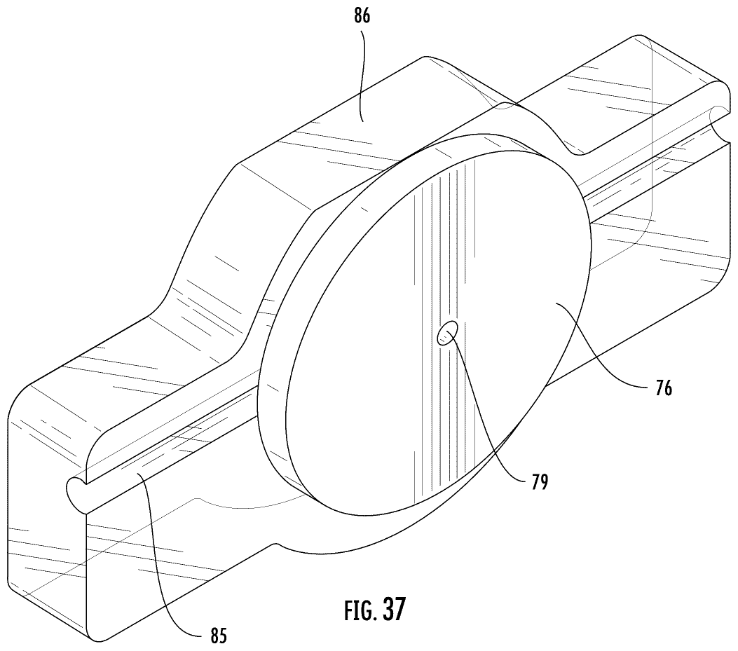

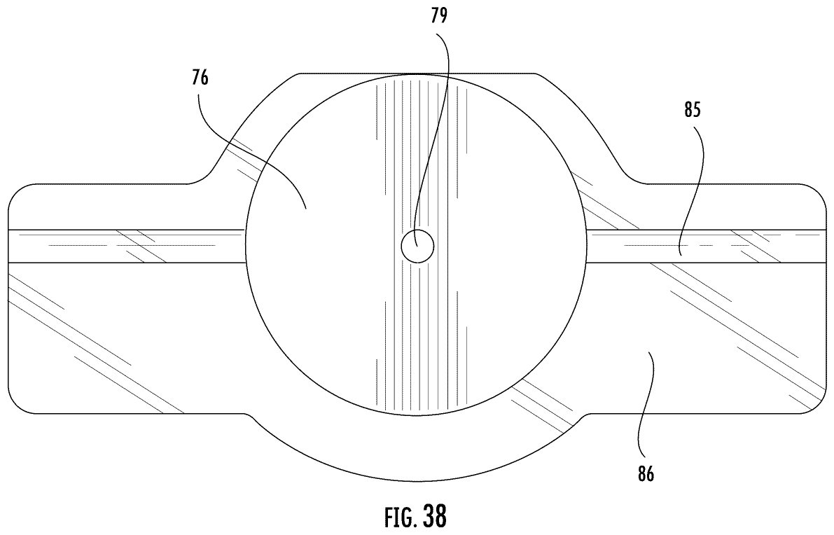

Detection alignment system platform 86 is positioned at outlet 49 of separation capillary 46 as shown in FIGS. 32 and 33. Detection alignment system platform 86 contains channel 85 to guide separation capillary 46 for proper alignment as shown in FIGS. 36-38. Separation capillary 46 includes window 50 where a beam of light of a detector (not shown) can passed through to monitor the individual selectively captured and enriched analytes that are separated along separation capillary 46 (not shown). Central portion 79 of capillary alignment interface tool 76 is placed and perfectly aligned in detection alignment system platform 86 for optimal passing of a beam of light from the detector unit (not shown) through window 50 of separation capillary 46 (not shown).

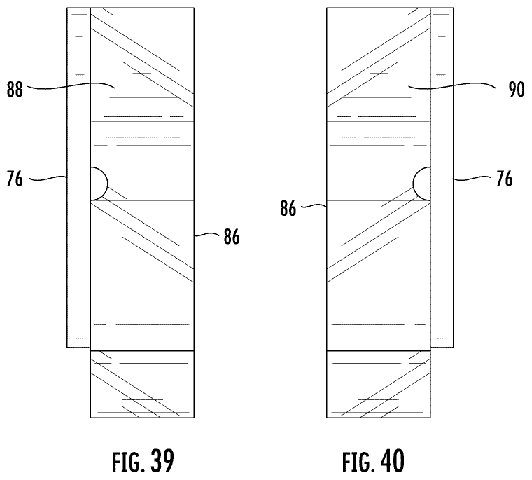

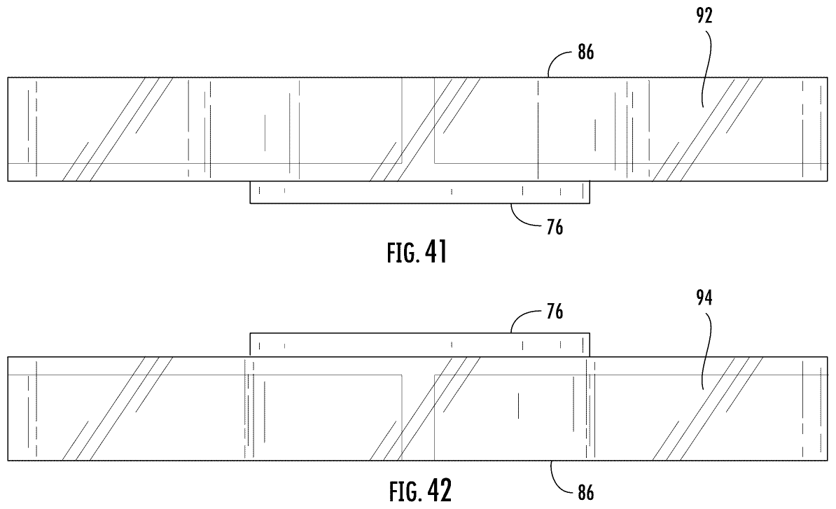

FIG. 39 illustrates front end 88 of detection alignment system platform 86 including received capillary alignment interface tool 76. FIG. 40 illustrates rear end 90 of detection alignment system platform 86 including received capillary alignment interface tool 76. FIG. 41 illustrates side 92 of detection alignment system platform 86 including received capillary alignment interface tool 76. FIG. 42 illustrates side 94 of detection alignment system platform 86 including received capillary alignment interface tool 76.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. An interchangeable support system comprising:
a support platform, said support platform comprising a main body having one or more apertures;
a docking support cartridge cassette;
one or more pole supports extending from said docking support cartridge cassette, the one or more pole supports being respectively removably received in the one or more respective apertures of the main body of the support platform; and
an analyte concentrator-microreactor (ACM) device being removably coupled to the support platform, wherein the interchangeable support system allows the analyte concentrator-microreactor (ACM) device to be expeditiously coupled to the docking support cartridge cassette.

2. The interchangeable support system according to claim 1, wherein the analyte concentrator-microreactor (ACM) device includes an aperture, one of the one or more supports removably received in the aperture of the analyte concentrator-microreactor (ACM) device for coupling the analyte concentrator-microreactor (ACM) device to the support platform.

3. The interchangeable support system according to claim 2 further comprising a screw for coupling the analyte concentrator-microreactor (ACM) device to the support platform.

4. The interchangeable support system according to claim 1, wherein the support platform having a central opening extending through a central portion of the main body of the support platform and the docking support cartridge cassette having a body extending from the docking support cartridge cassette, the body of the docking support cartridge cassette being received in the central opening of the main body of the support platform, the shape of the central opening and the shape of the body have corresponding shapes for providing complimentary docking alignment between the support platform and the docking support cartridge cassette.

5. The interchangeable support system according to claim 4, wherein the central opening has a cylindrical shape with an opening extension extending from the cylindrical shape and the body of the docking support cartridge cassette having a cylindrical tube shape with a protuberance extending from the cylindrical tube shape, the cylindrical tube shape and protuberance of the docking support cartridge being respectively received in the cylindrical shape and opening extension of the central opening.

6. The interchangeable support system according to claim 1, further comprising a retainer body, the retainer body including an opening, the retainer body being received over one of the pole supports after the pole support is received in the aperture of the main body.

7. The interchangeable support system according to claim 1, further comprising a transport or sample introduction capillary and a separation capillary, the transport or sample introduction capillary and the separation capillary being coupled to the analyte concentrator-microreactor (ACM) device, the transport or sample introduction capillary is a portion of the capillary where a sample and/or buffer and/or a plug of an elution buffer or solution is introduced and the separation capillary is a portion of the capillary where one or more components, chemicals, biochemicals, cellular-subcellular, vesicular and particulate entities separated in the sample are received and after separation are detected and characterized.

8. The interchangeable support system according to claim 7, further comprising one or more retainer bodies, each of the retainer bodies including an opening, a respective one of the one or more retainer bodies being received over one of the one or more pole supports after the pole support is received in the aperture of the main body for retaining the coupling of the support platform to the docking support cartridge cassette, each of the retainer bodies including side panels having an aperture therein, the separation capillary passing through the aperture in the side panels of the one or more retainer bodies.

9. The interchangeable support system according to claim 7, further comprising a detection alignment system platform, the detection alignment system platform being positioned at an outlet end of the separation capillary, the detection alignment system platform including a channel for receiving the separation capillary and guiding the separation capillary in proper alignment.

10. The interchangeable support system according to claim 9, wherein the separation capillary includes a window positioned over the detection alignment system platform, wherein the window receives a beam of light from a detector.

11. The interchangeable support system according to claim 10, wherein the window of the separation capillary is formed by removing a portion of a surface coating of the separation capillary.

12. The interchangeable support system according to claim 7, wherein the support platform includes a protrusion extending from the main body and an extension arm extending from the protrusion, the extension arm being a detection alignment system platform and having a channel to guide the separation capillary.

13. The interchangeable support system according to claim 12, wherein the separation capillary includes a window positioned over the detection alignment system platform, wherein the window receives a beam of light from a detector.

14. The interchangeable support system according to claim 13, wherein the window of the separation capillary is formed by removing a portion of a surface coating of the separation capillary.

15. A method for interchangeably connecting an analyte concentrator-microreactor (ACM) to a docking device cartridge cassette comprising the steps of:
coupling an analyte concentrator-microreactor (ACM) device to a support platform, the support platform comprising a main body having one or more apertures; and
receiving the one or more apertures of the support platform respectively on one or more pole supports extending from a docking support cartridge cassette,
wherein the analyte concentrator-microreactor (ACM) device is expeditiously coupled to the docking support cartridge cassette to perform molecular interactions selected from preconcentration, biochemical, metabolic and bioactivity studies.

16. The method according to claim 15, further comprising the step of:
receiving one or more retainer bodies respectively over one of the one or more pole supports after the pole support is received in the aperture of the main body for retaining the coupling of the support platform to the docking support cartridge cassette, each of the retainer bodies including side panels having an aperture therein; and
passing a separation capillary passing through the aperture in the side panels of the one or more retainer bodies.

17. The method according to claim 15 further comprising the step of:
receiving a separation capillary in a channel of a detection alignment system platform for guiding the separation capillary in proper alignment.

18. The method according to claim 17 wherein the separation capillary includes a window positioned over the detection alignment system platform, wherein the window receives a beam of light from a detector.

19. The method according to claim 15, wherein the support platform includes a protrusion extending from the main body and an extension arm extending from the protrusion, the extension arm being a detection alignment system platform and having a channel, and further comprising
receiving a separation capillary in the channel of the detection alignment system platform for guiding the separation capillary in proper alignment.

20. The method according to claim 19 wherein the separation capillary includes a window positioned over the detection alignment system platform, wherein the window receives a beam of light from a detector.
